(19) United States
(12) Patent Application Publication
(10) Pub. No.: US 2008/0177541 A1
(43) Pub. Date: Jul. 24, 2008

(54) Voice recognition device, voice recognition method, and voice recognition program

(75) Inventor: Masashi Satomura, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD.

(21) Appl. No.: 11/896,527

(22) Filed: Sep. 4, 2007

(30) Foreign Application Priority Data
Sep. 5, 2006 (JP) 2006-240639

(51) Int. Cl. G10L 15/00

(52) U.S. Cl. 704/251; 704/E15.001

(57) ABSTRACT

A voice recognition device, a voice recognition method, and a voice recognition program capable of recognizing a user's speech accurately even if the user's speech is ambiguous. The voice recognition device determines a control content of a control object on the basis of a recognition result of an input voice. The device includes a task type determination processing unit which determines the type of a task indicating the control content on the basis of a given determination input and a voice recognition processing unit which recognizes the input voice with the task of the type determined by the task type determination processing unit as a recognition object.

### BACKGROUND OF THE INVENTION

1. Field of the Invention

The present invention relates to a voice recognition device, a voice recognition method, and a voice recognition program for recognizing voice input from a user and obtaining information for use in controlling an object on the basis of a result of the recognition.

2. Related Background Art

In recent years, for example, in a system where a user operates apparatuses or the like, there has been used a voice recognition device which recognizes voice input from the user and obtains information (commands) necessary for operating the apparatuses or the like. This type of voice recognition device interacts with the user by recognizing voice (speech) input from the user and responding to the user based on the recognition result to prompt the user for the next speech. Then, information necessary to perform the device operations or the like is obtained from the result of the recognition of the interaction with the user. In this process, the voice recognition device recognizes the speech by comparing a feature value of the input speech with a feature value of a command registered in a voice recognition dictionary using the voice recognition dictionary in which commands to be recognized are previously registered, for example.

The voice recognition device is mounted, for example, on a vehicle, and the user operates a plurality of apparatuses such as an audio system, a navigation system, an air conditioner, and the like mounted on the vehicle. Further, these apparatuses are advanced in functions: for example, a navigation system has a plurality of functions such as a map display and a point of Interest (POI) search and a user operates these functions. If there are a lot of operational objects like this, however, the number of commands for operating them increases. Further, the increase in the number of commands to be recognized leads to an increase in situations where feature values of the commands are similar to each other, which increases the possibility of false recognition. Accordingly, there has been suggested a technology of improving the recognition accuracy by decreasing the number of commands by performing voice recognition processing with only limited commands as recognition objects to an operational object under interaction (for example, an application which is installed in the navigation system) according to a transition state of the user's speech (for example, a history of an interaction between the user and the device) (refer to, for example, Japanese Patent Laid-Open No. 2004-234273 [hereinafter, referred to as patent document 1]).

The voice recognition device (interactive terminal device) in patent document 1 has, as a command to be recognized, a local command for use in operating an application with which the user is interacting and a global command for use in operating applications other than the application with which the user is interacting. The voice recognition device then determines whether an input speech is a local command: if the voice recognition device determines that the speech is a local command, voice recognition processing as a local command is performed; otherwise, voice recognition processing as a global command is performed. This improves the recognition accuracy achieved when the user operates the application with which the user is interacting. In addition, this allows the voice recognition device to shift directly to an interaction with another application without a redundant operation such as, for example, terminating the application with which the user is interacting and returning to the menu before selecting another application, when the user tries to operate another application during interaction.

The above voice recognition device, however, cannot limit the command to be recognized, for example, unless the application is identified from the user's speech and therefore it cannot improve the recognition accuracy. Therefore, if the application is not identified and false recognition occurs in the case of ambiguous user's speech, the voice recognition device prompts the user to re-enter the speech repeatedly, for example. In addition, if a global command is similar to a local command in the above voice recognition device, for example, the input global command can be incorrectly recognized as the local command due to the ambiguous user's speech. If so, the user cannot shift to an interaction with another application from the application with which the user is interacting and therefore the voice recognition device is not user-friendly disadvantageously.

### SUMMARY OF THE INVENTION

In view of the above circumstances, it is an object of the present invention to provide a voice recognition device, a voice recognition method, and a voice recognition program capable of recognizing a user's speech accurately even if the user's speech is ambiguous.

According to a first aspect of the present invention, there is provided a voice recognition device which determines a control content of a control object on the basis of a recognition result of an input voice, comprising: a task type determination processing unit which determines the type of a task indicating the control content on the basis of a given determination input; and a voice recognition processing unit which recognizes the input voice with the task of the type determined by the task type determination processing unit as a recognition object (First invention).

In the voice recognition device according to the first invention, for example, a user inputs a speech for controlling an object with voice, and the voice recognition processing unit recognizes the voice and thereby obtains information for controlling the object. At this point, the information for controlling the object is roughly classified into a domain indicating the control object and a task indicating the control content.

The “domain” is information indicating “what” the user controls as an object with a speech. More specifically, the domain indicates an apparatus or a function which is an object to be controlled by the user with the speech. For example, it indicates an apparatus such as “a navigation system,” “an audio system,” or “an air conditioner” in the vehicle, a content such as “a screen display” or “a POI search” of the navigation system, or a device such as “a radio” or “a CD” of the audio system. For example, an application or the like installed in the navigation system is included in the domain. In addition, the “task” is information indicating “how” the user controls the object with the speech. More specifically, the task indicates an operation such as “setup change,” “increase,” and “decrease.” The task includes a general operation likely to be performed in common for a plurality of apparatuses or functions.

In this case, for example, if a user's speech is ambiguous, the assumed situation is that at least how the object is controlled is identified, though what is controlled is not identified. For this situation, according to the present invention, when the task type determination processing unit determines the task indicating the control content on the basis of the given determination input, the voice recognition processing is performed with the recognition object limited to the determined type of the task. Accordingly, even if what should be controlled is not identified, the recognition object can be limited with an index of how the object should be controlled in the voice recognition processing, which improves the recognition accuracy for an ambiguous speech.

Furthermore, preferably the voice recognition device according to the first invention further comprises a domain type determination processing unit which determines the type of a domain indicating the control object on the basis of the given determination input, and the voice recognition processing unit recognizes the input voice with the domain of the type determined by the domain type determination processing unit as a recognition object, in addition to the task of the type determined by the task type determination processing unit (Second invention).

In the above, if the domain indicating the control object is determined in addition to the task indicating the control content, the voice recognition processing is performed with the recognition object limited to both of the task and domain of the determined type. This allows the voice recognition processing to be performed with the recognition object efficiently limited, which further improves the recognition accuracy.

In the voice recognition device according to the first or second invention, preferably the given determination input for determining the type of the task is data indicating a task included in a previous recognition result in the voice recognition processing unit regarding sequentially input voices (Third invention).

In the above, the task type is determined on the basis of the previous speech from the user, and therefore the voice recognition processing can be performed with the recognition object efficiently limited in the interaction with the user. The given determination input for determining the task type can be data indicating a task included in an input to a touch panel, a keyboard, or an input interface having buttons or dials or the like. Furthermore, the determination input for determining the domain type can be data indicating a domain included in the previous recognition result, an input to the input interface, or the like similarly to the task.

Furthermore, preferably the voice recognition device according to the first or second invention has voice recognition data classified into at least the task types for use in recognizing the voice input by the voice recognition processing unit, and the voice recognition processing unit recognizes the input voice at least on the basis of the data classified in the task of the type determined by the task type determination processing unit among the voice recognition data (Fourth invention).

In the above, if the task indicating the control content is determined, the voice recognition processing unit performs processing of recognizing the voice by using voice recognition data classified in the task of the determined type among the voice recognition data as the voice recognition processing where the recognition object is limited to the determined type of the task. Thereby, the voice recognition processing can be performed with the recognition object limited using the index of how the object should be controlled even if what should be controlled is not identified, whereby the recognition accuracy can be improved for an ambiguous speech.

Furthermore, preferably the voice recognition device according to the third invention has voice recognition data classified into the task and domain types for use in recognizing the voice input by the voice recognition processing unit, and the voice recognition processing unit recognizes the input voice on the basis of the data classified in the task of the type determined by the task type determination processing unit and in the domain of the type determined by the domain type determination processing unit among the voice recognition data (Fifth invention).

In the above, if the domain indicating the control object is determined in addition to the task indicating the control content, the voice recognition processing unit performs processing of recognizing the voice by using voice recognition data classified in both of the determined type of task and the determined type of domain as the voice recognition processing where the recognition object is limited to both of the determined task type and domain type. Thereby, the voice recognition processing can be performed with the recognition object limited efficiently, and therefore the recognition accuracy can be improved.

Further, in the voice recognition device according to a fourth or fifth invention, the voice recognition data preferably includes a language model having at least a probability of a word to be recognized as data (Sixth invention).

In the above, the term “language model” means a statistical language model based on an appearance probability or the like of a word sequence, which indicates a linguistic feature of the word to be recognized. In the voice recognition using the linguistic model, for example, not only a previously registered command, but also a user's natural speech which is not limited in expression can be accepted. In an ambiguous speech not limited in expression like this, there is a high possibility that the domain type is not determined, but only the task type is determined. Therefore, in the case where only the task type is determined, the data of the language model is limited to this type of the task to perform the voice recognition processing, by which an effect of improving the recognition accuracy can be remarkably achieved.

Further, preferably the voice recognition device according to the first to sixth inventions further comprises a control processing unit which determines the control content of the control object at least on the basis of the recognition result of the voice recognition processing unit and performs a given control process (Seventh invention).

In the above, the control processing unit determines and performs the given control process, for example, out of a plurality of previously determined control processes (scenarios) according to the recognition result of the voice recognition processing unit. The given control process is processing of controlling an apparatus or a function to be controlled on the basis of the information obtained from the speech or processing of controlling a response with voice or screen display to the user. In the processing, according to the present invention, the recognition accuracy is improved also for a user's ambiguous speech, and therefore the given control process can be appropriately determined and performed according to a user's intention.

The control processing unit can also determine and perform the given control process in consideration of a state of a system (for example, a vehicle) on which the voice recognition device is mounted, a user's condition, a state of an apparatus or function to be controlled, or the like, in addition to the recognition result of the speech. Furthermore, the control processing unit can be provided with a memory which stores a user's interaction history, the change of state of an apparatus, or the like so as to determine the given control process in consideration of the interaction history or the change of state in addition to the recognition result of the speech.

Moreover, preferably the voice recognition device according to the seventh invention further comprises a response output processing unit which outputs a response to a user inputting the voice, and the control process performed by the control processing unit includes processing of controlling the response to the user to prompt the user to input the voice (Eighth invention).

In the above, for example, if information for controlling the object cannot be obtained sufficiently from the speech input from the user, the control processing unit controls the response to be output from the response output processing unit so as to prompt the user to input necessary information. This causes an interaction with the user and the necessary information for controlling the object is obtained from the result of the recognition of the interaction with the user. In this process, according to the present invention, the recognition accuracy is improved also for a user's ambiguous speech and therefore information can be obtained through an efficient interaction.

Then, according to a second aspect of the present invention, there is provided a voice recognition device having a microphone to which a voice is input and a computer having an interface circuit for use in accessing data of the voice obtained via the microphone, the voice recognition device determining a control content of a control object on the basis of a recognition result of the voice input to the microphone through arithmetic processing with the computer, wherein the computer performs: task type determination processing of determining the type of a task indicating the control content on the basis of a given determination input; and voice recognition processing of recognizing the input voice with the task of the type determined in the task type determination processing as a recognition object (Ninth invention).

According to the voice recognition device according to the second aspect, the arithmetic processing of the computer can bring about the effect described regarding the voice recognition device of the first invention.

Then, according to the present invention, there is provided a voice recognition method of determining a control content of a control object on the basis of a recognition result of an input voice, comprising: a task type determination step of determining the type of a task indicating the control content on the basis of a given determination input; and a voice recognition step of recognizing the input voice with the task of the type determined in the task type determination step as a recognition object (10th invention).

According to the voice recognition method, as described regarding the voice recognition device of the first invention, the voice recognition processing can be performed with the recognition object limited only if at least how the object should be controlled is identified even if what should be controlled is not identified. Therefore, according to the voice recognition method, the recognition accuracy of the voice recognition can be improved also for a user's ambiguous speech.

Subsequently, according to the present invention, there is provided a voice recognition program which causes a computer to perform processing of determining a control content of a control object on the basis of a recognition result of an input voice, having a function of causing the computer to perform: task type determination processing of determining the type of a task indicating the control content on the basis of a given determination input; and voice recognition processing of recognizing the input voice with the task of the type determined in the task type determination processing as a recognition object (11th invention).

According to the voice recognition program, it is possible to cause the computer to perform the processing which brings about the effect described regarding the voice recognition device of the first invention.

### BRIEF DESCRIPTION OF THE DRAWINGS

FIG. 1 is a functional block diagram of a voice recognition device which is one embodiment of the present invention;

FIG. 2 is an explanatory diagram showing a configuration of a language model, a parser model, and a proper noun dictionary of the voice recognition device in FIG. 1;

FIG. 3 is an explanatory diagram showing a configuration of the language model of the voice recognition device in FIG. 1;

FIG. 4 is a flowchart showing a general operation (voice interaction processing) of the voice recognition device in FIG. 1;

FIG. 5 is an explanatory diagram showing voice recognition processing using the language model in the voice interaction processing in FIG. 4;

FIG. 6 is an explanatory diagram showing parsing processing using the parser model in the voice interaction processing in FIG. 4;

FIG. 7 is an explanatory diagram showing a form for use in processing of determining a scenario in the voice interaction processing in FIG. 4;

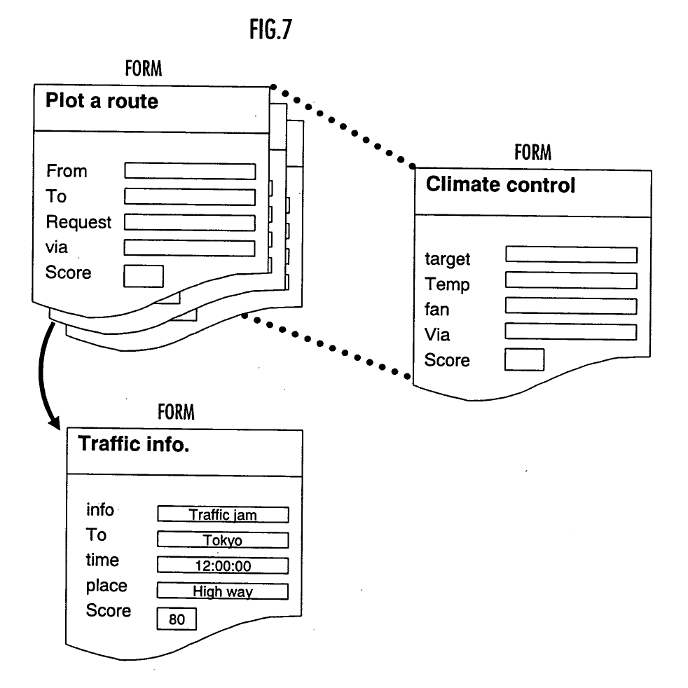

FIG. 8 is an explanatory diagram showing the processing of determining a scenario in the voice interaction processing in FIG. 4;

FIG. 9 is an explanatory diagram showing processing of selecting a language model in the voice interaction processing in FIG. 4; and

FIG. 10 is an explanatory diagram showing an example of interaction in the voice interaction processing in FIG. 4.

### DETAILED DESCRIPTION OF THE PREFERRED EMBODIMENTS

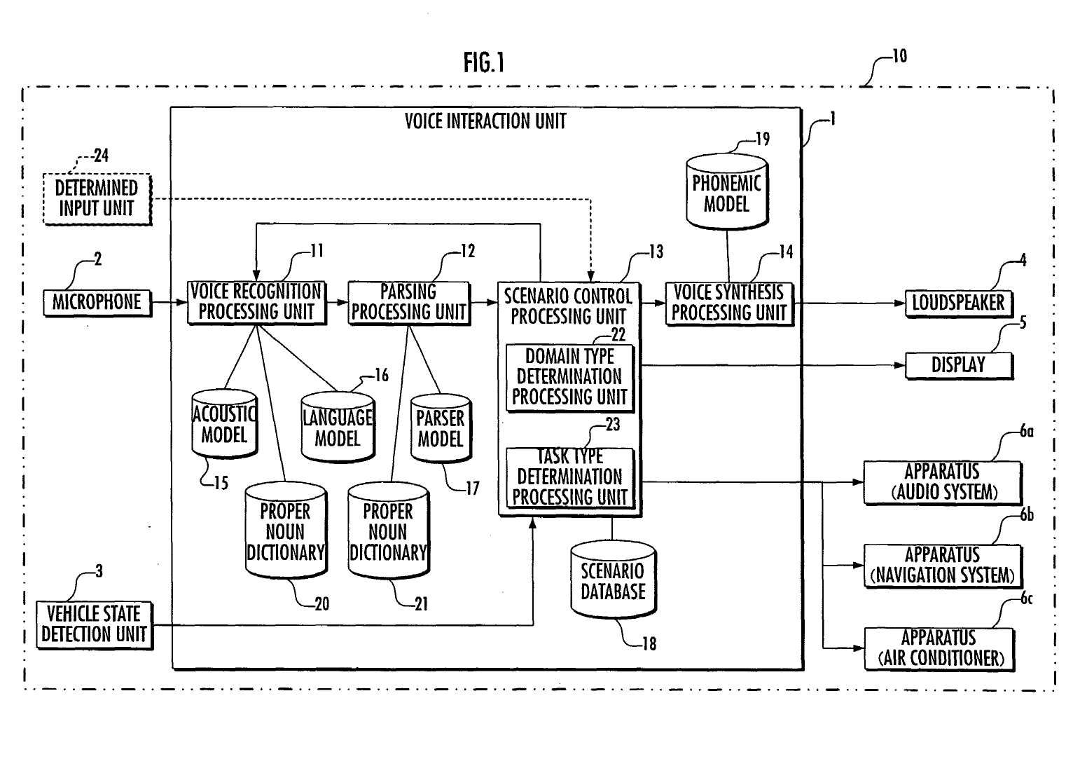

As shown in FIG. 1, a voice recognition device according to an embodiment of the present invention includes a voice interaction unit 1 and is mounted on a vehicle 10. The voice interaction unit 1 is connected to a microphone 2 to which a speech is input from a driver of the vehicle 10 and is connected to a vehicle state detection unit 3 which detects the state of the vehicle 10. In addition, the voice interaction unit 1 is connected to a loudspeaker 4 which outputs a response to the driver and to a display 5 which provides a display to the driver. Further, the voice interaction unit 1 is connected to a plurality of apparatuses 6a to 6c which can be operated by the driver using voice or the like.

The microphone 2 is for use in inputting the voice of the driver of the vehicle 10 and is installed in a given position in the vehicle. The microphone 2 obtains an input voice as a driver's speech, for example, when the start of voice input is ordered using a talk switch. The talk switch is an on-off switch operated by the driver of the vehicle 10 and the start of the voice input is ordered by depressing the talk switch to turn on the switch.

The vehicle state detection unit 3 is a sensor or the like which detects the state of the vehicle 10. The state of the vehicle 10 means, for example, a running condition such as a speed or acceleration and deceleration of the vehicle 10, driving environment information such as the position or running road of the vehicle 10, operating states of apparatuses (a wiper, a winker, a navigation system 6a, an audio system 6b, and the like) mounted on the vehicle 10, or an in-vehicle state such as an in-vehicle temperature of the vehicle 10. More specifically, sensors which detects the running condition of the vehicle 10 can be, for example, a vehicle speed sensor which detects a running speed (vehicle speed) of the vehicle 10, a yaw rate sensor which detects a yaw rate of the vehicle 10, a brake sensor which detects a brake operation (whether a brake pedal is operated) of the vehicle 10. Further, the vehicle state detection unit 3 can detect the driver's condition (perspiration of driver's palms, a driving load on the driver, or the like) as the state of the vehicle 10.

The loudspeaker 4 outputs a response (audio guide) to the driver of the vehicle 10. The loudspeaker 4 can be a loudspeaker of the audio system 6a described later.

The display 5 is, for example, a head-up display (HUD) which displays an image or other information on a front window of the vehicle 10, a display which is integrally provided in a meter which displays the running condition such as a vehicle speed of the vehicle 10, or a display provided in the navigation system 6b described later. The display of the navigation system 6b has a touch panel in which touch switches are incorporated.

The apparatuses 6a to 6c are specifically the audio system 6a, the navigation system 6b, and the air conditioner 6c mounted on the vehicle 10. The apparatuses 6a to 6c each have previously determined controllable components (devices, contents, or the like), functions, operations, and the like.

For example, the audio system 6a includes devices such as “a CD,” “an MP3,” “a radio,” and “a loudspeaker.” There are functions of the audio system 6a such as “sound volume” and the like. Further, there are operations of the audio system 6a such as “change,” “ON,” and “OFF.” Further, there are “reproduction,” “stop,” and the like as operations of the “CD” and “MP3.” In addition, there are “channel selection” and the like as the functions of the “radio.” Further, there are “increase,” “decrease,” and the like as “sound volume” operations.

Furthermore, for example, the navigation system 6b has contents such as “screen display,” “route guidance,” and “POI search.” Furthermore, the operations of “screen display” include “change,” “magnification,” “reduction,” and the like. The “route guidance” function guides a driver to a destination using an audio guide or the like, and the “POI search” function searches for a destination such as, for example, a restaurant or a hotel.

Additionally, for example, the air conditioner 6c has functions of “air quantity,” “preset temperature,” and the like. The operations of the air conditioner 6c include “ON” and “OFF” operations. Further, the operations of “air quantity” and “preset temperature” include “change,” “increase,” and “decrease.”

These apparatuses 6a to 6c are controlled by specifying information (the type of apparatus or function, the content of an operation, or the like) for controlling an object. The information for controlling the object is information indicating “what” and “how” the object is to be controlled and it is classified roughly in a domain indicating the control object (information indicating “what” should be controlled as an object) and a task indicating the control content (information indicating “how” the object should be controlled). The domain corresponds to the type of apparatuses 6a to 6c or the type of devices, contents, and functions of the apparatuses 6a to 6c. The task corresponds to the content of the operations of the apparatuses 6a to 6c and it includes the operation performed in common to the plurality of domains such as, for example, “change,” “increase,” and “decrease” operations. The domain and the task can be specified hierarchically such that the “audio system” domain is classified into domains “CD” and “radio” under the domain.

Although not shown in detail, the voice interaction unit 1 is an electronic unit including a computer (a CPU, a memory, an arithmetic processing circuit including input-output circuits or the like, or a microcomputer having these functions collected) which performs various arithmetic processing for the voice data, having a memory which stores voice data and an interface circuit which accesses (reads and writes) data stored in the memory. The memory which stores the voice data can be an internal memory of the computer or an external storage medium.

In the voice interaction unit 1, the output (analog signal) of the microphone 2 is converted to a digital signal via an input circuit (A/D converter circuit, or the like) before input. Then, the voice interaction unit 1 performs a process of recognizing a speech input from the driver on the basis of the input data, a process of interacting with the driver or of providing information to the driver via the loudspeaker 4 or the display 5 on the basis of the recognition result, and a process of controlling the apparatuses 6a to 6c. These processes are performed by executing a program previously implemented in the memory of the voice interaction unit 1 using the voice interaction unit 1. This program includes a voice recognition program of the present invention. The program can be stored in the memory via a recording medium such as a CD-ROM or can be stored in the memory after it is distributed or broadcasted via a network or a satellite from an external server and then received by a communication device mounted on the vehicle 10.

More specifically, as the functions performed by the above program, the voice interaction unit 1 includes a voice recognition processing unit 11 which recognizes an input voice using an acoustic model 15 and a language model 16 and outputs it as a text and a parsing processing unit 12 which understands the meaning of the speech using a parser model 17 from the recognized text. The voice interaction unit 1 includes a scenario control processing unit 13 which determines a scenario using a scenario database 18 on the basis of the recognition result of the speech before responding to the driver or controlling the apparatuses and a voice synthesis processing unit 14 which synthesizes the voice response output to the driver using a phonemic model 19. Furthermore, the scenario control processing unit 13 includes a domain type determination processing unit 22 which determines the type of a domain from the recognition result of the speech and a task type determination processing unit 23 which determines the type of a task from the recognition result of the speech.

The acoustic model 15, the language model 16, the parser model 17, the scenario database 18, the phonemic model 19, and the proper noun dictionaries 20 and 21 are recording mediums (databases) of a CD-ROM, a DVD, a HDD, and the like in which data is recorded, respectively.

Furthermore, the language model 16 and the proper noun dictionary 20 constitute voice recognition data of the present invention. The scenario control processing unit 13 constitutes a control processing unit of the present invention. Further, the scenario control processing unit 13 and the voice synthesis processing unit 14 constitute a response output processing unit of the present invention.

The voice recognition processing unit 11 performs frequency analysis of waveform data indicating the voice of a speech input to the microphone 2 to extract a feature vector. Thereafter, the voice recognition processing unit 11 recognizes the input voice on the basis of the extracted feature vector and performs “voice recognition processing” to be output as a text represented by a word sequence. The voice recognition processing is performed by comprehensively determining an acoustic feature and a linguistic feature of the input voice using a probability and statistical method as described below.

Specifically, the voice recognition processing unit 11 first evaluates a likelihood of pronunciation data corresponding to the extracted feature vector (hereinafter, the likelihood is appropriately referred to as “sound score”) using the acoustic model 15 and then determines the pronunciation data on the basis of the sound score. The voice recognition processing unit 11 evaluates a likelihood of the text represented by the word sequence corresponding to the determined pronunciation data (hereinafter, the likelihood is appropriately referred to as “language score”) using the language model 16 and the proper noun dictionary 20 and then determines the text on the basis of the language score. Furthermore, the voice recognition processing unit 11 calculates a confidence factor of voice recognition (hereinafter, the confidence factor is appropriately referred to as “voice recognition score”) on the basis of the sound score and the language score of the text for all texts determined. Then, the voice recognition processing unit 11 outputs a text, whose voice recognition score is represented by a word sequence which satisfies a given condition, as a recognized text.

Then, if the types of the domain and the task are determined by the domain type determination processing unit 22 and the task type determination processing unit 23, the voice recognition processing unit 11 performs the voice recognition processing using only data of parts classified in the determined domain and task (effective parts) out of the language model 16 and the proper noun dictionary 20.

The “score” means an exponent indicating plausibility (likelihood or confidence factor) in which a candidate obtained as the recognition result corresponds to the input voice from various viewpoints such as an acoustic viewpoint and a linguistic viewpoint.

The parsing processing unit 12 performs “parsing processing” of understanding the meaning of the input speech using the parser model 17 and the proper noun dictionary 21 from the text recognized by the voice recognition processing unit 11. The parsing processing is performed by analyzing a relationship (syntax) between words in the text recognized by the voice recognition processing unit 11 using the probability and statistical method as described below.

Specifically, the parsing processing unit 12 evaluates the likelihood of the recognized text (hereinafter, the likelihood is appropriately referred to as “parsing score”) and determines the text categorized in a class corresponding to the meaning of the recognized text on the basis of the parsing score. Then, the parsing processing unit 12 outputs a text categorized in a class (categorized text) whose parsing score satisfies a given condition as a recognition result of the input speech together with the parsing score. The term “class” corresponds to a sort according to the category to be recognized, and more specifically corresponds to the domain or task described above. For example, if the recognized text is “Setup change,” “Make setup change,” “Change setup,” or “Setting change,” the categorized text is (setup) in all cases.

The scenario control processing unit 13 determines a scenario of a response output or an apparatus control to the driver by using data recorded in the scenario database 18 at least on the basis of the recognition result output from the parsing processing unit 12 and the state of the vehicle 10 obtained from the vehicle state detection unit 3. The scenario database 18 previously contains records of a plurality of scenarios for the response output or the apparatus control together with the recognition result of the speech and the condition of the vehicle state. Then, the scenario control processing unit 13 performs processing of controlling a response with voice or image display or processing of controlling apparatuses according to a determined scenario. Specifically, in the case of a response with voice, the scenario control processing unit 13 determines the content of a response to be output (a response sentence for prompting a driver for the next speech or a response sentence for notifying a user of the completion of the operation or the like) or the speed or sound volume of the response to be output.

The voice synthesis processing unit 14 synthesizes the voice using the phonemic model 19 according to the response sentence determined by the scenario control processing unit 13 and outputs it as waveform data indicating the voice. The voice is synthesized, for example, by using text-to-speech (TTS) or other processing. Specifically, the voice synthesis processing unit 14 normalizes the text of the response sentence determined by the scenario control processing unit 13 to representation appropriate to the voice output and converts respective words of the normalized text to pronunciation data. Then, the voice synthesis processing unit 14 determines a feature vector from the pronunciation data by using the phonemic model 19 and filters the feature vector to convert it to waveform data. The waveform data is output as voice from the loudspeaker 4.

The acoustic model 15 contains a record of data indicating probabilistic correspondence between the feature vector and the pronunciation data. More specifically, the acoustic model 15 contains a record of a plurality of hidden Markov models (HMM) prepared for each recognition unit (phoneme, morpheme, word, or the like) as data. The HMM is a statistic signal source model in which voice is represented by a connection of stationary signal sources (states) and the time sequence is represented by a transition probability from one state to the next state. HMM allows the acoustic feature of the voice varying in time series to be represented by a simple probability model. Parameters of the transition probability of HMM and the like are previously determined by giving corresponding learning voice data for learning. In addition, the phonemic model 19 has a record of HMMs similar to the acoustic model 15 for use in determining a feature vector from pronunciation data.

The language model 16 contains a record of data indicating an appearance probability or a connection probability of a word to be recognized together with the pronunciation data of the word and a text. The word to be recognized is previously determined as a word likely to be used in the speech for controlling the object. Data of the appearance probability or the connection probability of the word is statistically generated by analyzing a large quantity of learning text corpus. Further, the appearance probability of the word is calculated, for example, on the basis of the appearance frequency or the like of the word in the learning text corpus.

For the language model 16, there is used, for example, an N-gram language model which is represented by a probability in which specific N words occur in succession. In this embodiment, an N-gram according to the number of words included in the input speech is used for the language model 16. More specifically, an N-gram in which the N value is equal to or less than the number of words included in the pronunciation data is used for the language model 16. For example, if the number of words included in the pronunciation data is 2, there are used uni-gram (N=1) represented by an appearance probability of one word and bi-gram (N=2) represented by an occurrence probability of a sequence of two words (a conditional appearance probability for preceding one word).

Furthermore, in the language model 16, the N value can be limited to a given upper limit when the N-gram is used. As a given upper limit, for example, it is possible to use a previously determined given value (for example, N=2) or a value sequentially set in such a way that the processing time of the voice recognition processing of the input speech is suppressed to within a given time period. For example, if the N-gram is used with the upper limit set to 2 (N=2), only uni-gram and bi-gram are used even if the number of words included in the pronunciation data is greater than 2. This prevents the computation cost of the voice recognition processing to increase excessively, by which a response can be output to a driver's speech in an appropriate response time.

The parser model 17 contains a record of data indicating an appearance probability or a connection probability of a word to be recognized together with the text and class of the word. For the parser model 17, for example, an N-gram language model is used similarly to the language model 16. In this embodiment, specifically, there is used N-gram in which the N value is equal to or less than the number of words included in the recognized text with the upper limit set to 3 (N=3). In other words, in the parser model 17, there are used uni-gram, bi-gram, and tri-gram (N=3) represented by an occurrence probability of a sequence of three words (a conditional appearance probability of preceding two words). The upper limit can be other than 3 and can be set arbitrarily. In addition, it is also possible to use N-gram in which the N value is equal to or less than the number of words included in the recognized text without limitation to the upper limit.

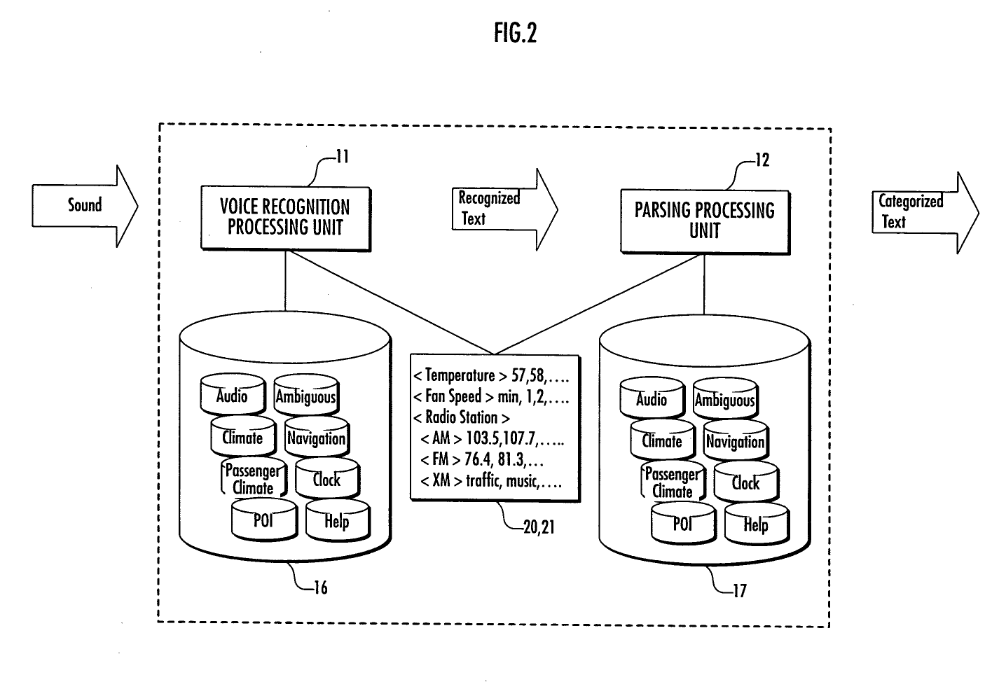

Pronunciation data and texts of proper nouns out of the words to be recognized such as a person's name, a place name, a frequency of a radio station, or the like are registered in the proper noun dictionaries 20 and 21. These data are recorded with tags such as <Radio Station> and <AM> as shown in FIG. 2. The content of the tag indicates a class of each proper noun registered in the proper noun dictionaries 20 and 21.

As shown in FIG. 2, the language model 16 and the parser model 17 are generated with being classified in each domain type. In the example shown in FIG. 2, there are eight types of domains, {Audio, Climate, Passenger Climate, POI, Ambiguous, Navigation, Clock, and Help}. {Audio} indicates that the control object is the audio system 6a. {Climate} indicates that the control object is the air conditioner 6c. {Passenger Climate} indicates that the control object is the air conditioner 6c for a passenger's seat. {POI} indicates that the control object is a POI search function of the navigation system 6b. {Navigation} indicates that the control object is a route guidance, a map operation, or other functions of the navigation system 6b. {Clock} indicates that the control object is a clock function. {Help} indicates that the control object is a help function for learning an operation method of the apparatuses 6a to 6c or the voice recognition device. {Ambiguous} indicates that the control object is ambiguous.

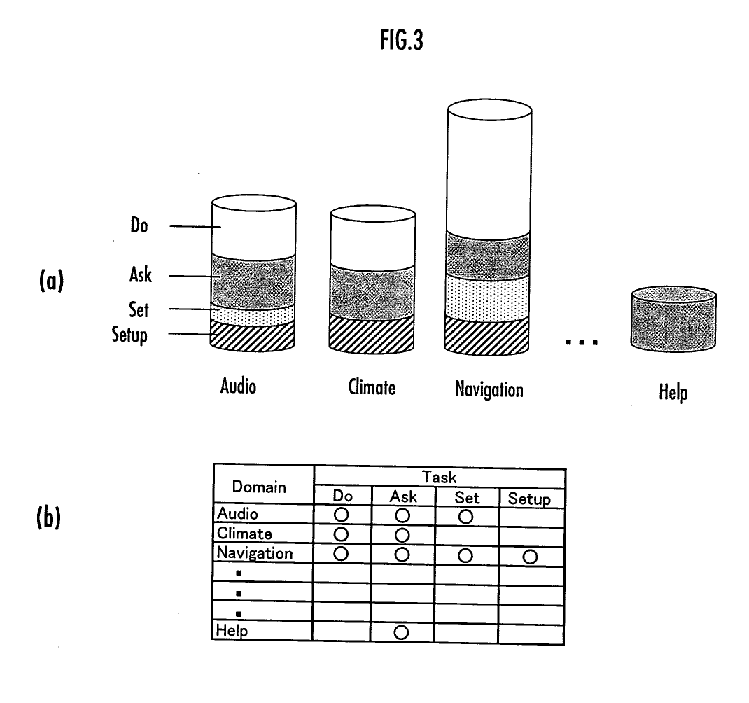

Further, as shown in FIG. 3, the language model 16 is generated with being further classified in each task type. In the example shown in FIG. 3, there are the above eight types of domains and four types of tasks {Do, Ask, Set, and Setup}. As shown in FIG. 3(a), for example, a word whose domain type is {Audio} has a task type of one of {Do}, {Ask}, {Set}, and {Setup}. For example, a word whose domain type is {Help} has only a task type {Ask} and has none of {Do}, {Set}, and {Setup}. FIG. 3(b) shows combinations where a word exists with the abscissa axis as a task type and the ordinate axis as a domain type using white circles, respectively. In this manner, the language model 16 is classified in a matrix with domains and tasks as indices. The proper noun dictionary 20 is also classified in a matrix with domains and tasks as indices in the same manner as the language model 16.

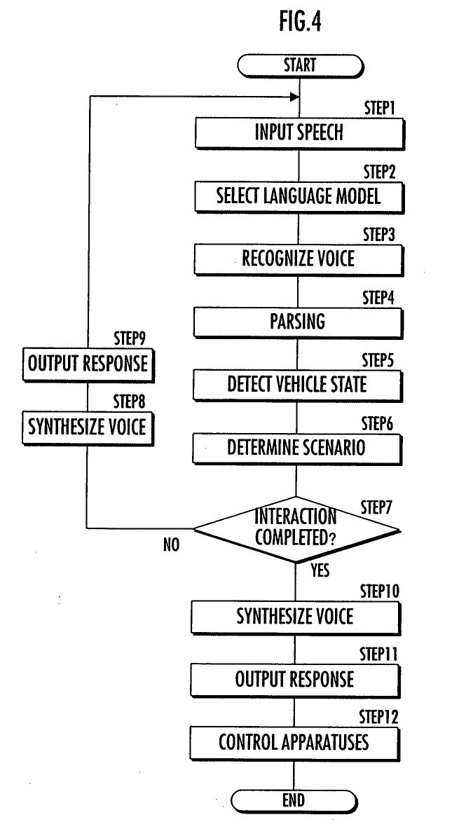

Subsequently, the operation (voice interaction processing) of the voice recognition device according to this embodiment will be described below. As shown in FIG. 4, first, in step 1, the driver of the vehicle 10 inputs a speech for controlling an object into the microphone 2. Specifically, the driver orders the start of the speech input by turning on the talk switch and inputs his/her voice to the microphone 2.

Subsequently, in step 2, the voice interaction unit 1 selectively validates data of the language model 16 and of the proper noun dictionary 20. Specifically, the voice interaction unit 1 performs processing of determining the type of domain of the input speech and processing of determining the type of task of the input speech from the recognition result of the previous speech. Note that the types of the domain and task are not determined because of the first speech, but the entire data of the language model 16 and the proper noun dictionary 20 is validated.

Then, in step 3, the voice interaction unit 1 performs voice recognition processing of recognizing the input voice and outputting it as a text.

First, the voice interaction unit 1 obtains waveform data indicating voice by A-D converting the voice input into the microphone 2. Then, the voice interaction unit 1 extracts a feature vector by performing a frequency analysis of waveform data indicating the voice. This causes the waveform data indicating the voice to be filtered by a method of, for example, a short time spectrum analysis and it is converted to the time series of the feature vector.

The feature vector, which is obtained by extracting a feature value of a voice spectrum at each time point, is generally 10 to 100 dimensions (for example, 39 dimensions), and a linear predictive coding (LPC) mel cepstrum coefficient or the like is used for it.

Subsequently, the voice interaction unit 1 evaluates a likelihood (sound score) of an extracted feature vector for each of the plurality of HMMs recorded in the acoustic model 15. Then, the voice interaction unit 1 determines pronunciation data corresponding to an HMM having a high sound score among the plurality of HMMs. Thereby, for example, if a speech “Chitose” is input, pronunciation data “chi-to-se” is obtained together with its sound score from the waveform data of the voice. For example, if a speech “mark set” is input then, acoustically highly similar pronunciation data such as “ma-a-ku-ri-su-to” is obtained together with the sound score in addition to the pronunciation data “ma-a-ku-se-t-to”.

Subsequently, the voice interaction unit 1 determines a text represented by a word sequence from the determined pronunciation data on the basis of the language score of the text. If a plurality of pronunciation data are determined then, texts are determined for the pronunciation data, respectively.

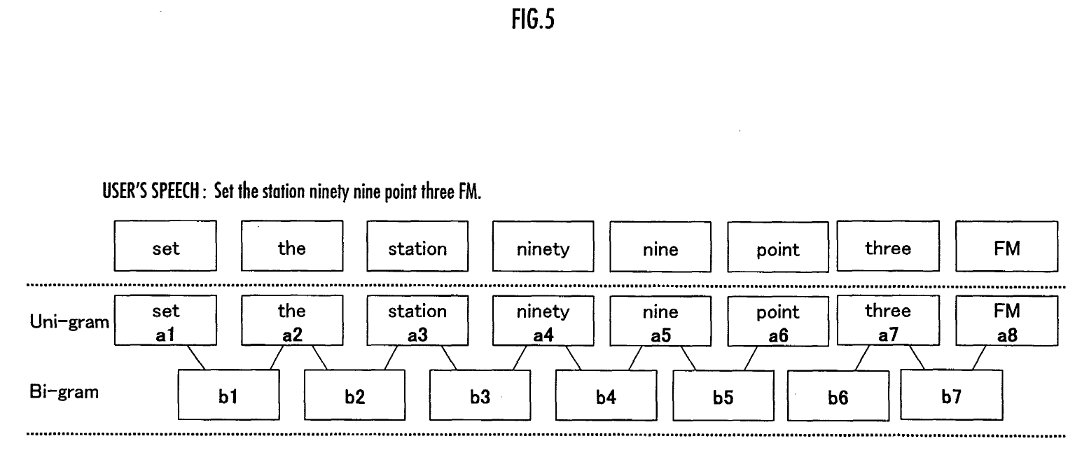

First, the voice interaction unit 1 determines a text from the pronunciation data using data validated in step 2 out of the language model 16. Specifically, first, the voice interaction unit 1 compares the determined pronunciation data with the pronunciation data recorded in the language model 16 and extracts highly similar words. Then, the voice interaction unit 1 calculates language scores of the extracted words by using the N-gram according to the number of words included in the pronunciation data. Thereafter, the voice interaction unit 1 determines a text where the calculated language score satisfies a given condition (for example, equal to or higher than a given value) for each word in the pronunciation data. For example, as shown in FIG. 5, if the input speech is “Set the station ninety nine point three FM,” “set the station ninety nine point three FM” is determined as a text corresponding to the pronunciation data determined from the speech.

In the above, appearance probabilities a1 to a8 of “set,” “the, . . . and “FM” are given in uni-gram, respectively. Further, in bi-gram, occurrence probabilities b1 to b7 of two words, “set the,” “the station,” . . . and “three FM” are given, respectively. Similarly, occurrence probabilities c1 to c6, d1 to d5, e1 to e4, f1 to f3, g1 to g2, and h1 of N words are given for N set to 3 to 8 (N=3 to 8). Then, for example, the language score of the text “ninety” is calculated on the basis of a4, b3, c2, and d1 obtained from the N-gram of N set to 1 to 4 (N=1 to 4) according to the number of words 4 which is obtained by adding the word “ninety” included in the pronunciation data to the words preceding the word concerned.

By using a method of writing the input speech as a text using a probability and statistical language model for each word (dictation) in this manner, a driver's natural speech can be recognized without limitation to speeches made of given expressions.

Subsequently, the voice interaction unit 1 determines a text from pronunciation data using data validated in step 2 out of the proper noun dictionary 20. Specifically, first, the voice interaction unit 1 calculates the degree of similarity between the determined pronunciation data and the pronunciation data of a proper noun registered in the proper noun dictionary 20. It then determines a proper noun whose degree of similarity satisfies a given condition out of the plurality of registered proper nouns. The given condition is previously determined, for example, such that the degree of similarity should be equal to or higher than a given value where their pronunciation data are clearly thought to be consistent with each other. In addition, the likelihood (language score) of the determined proper noun is calculated on the basis of the calculated degree of similarity.

By using the proper noun dictionary 20 in this manner, a text can be accurately determined for a proper noun whose appearance frequency in a text corpus is relatively low and whose expression is limited in comparison with general words easy to be used for various expressions.

Subsequently, the voice interaction unit 1 calculates a weighted sum between the sound score and the language score as a confidence factor of the voice recognition (voice recognition score) for all texts determined using the language model 16 and the proper noun dictionary 20. As a weighting factor, for example, a value previously determined on an experimental basis is used.

Subsequently, the voice interaction unit 1 determines and outputs a text represented by a word sequence whose calculated voice recognition score satisfies a given condition as a recognized text. The given condition is previously determined such as, for example, a text whose voice recognition score is the highest, a text whose voice recognition score ranges from a high order to a given order, or a text whose voice recognition score is equal to or higher than a given value.

Subsequently, in step 4, the voice interaction unit 1 performs parsing processing where the meaning of a speech is understood from the recognized text.

First, the voice interaction unit 1 determines a categorized text from the recognized text by using the parser model 17. Specifically, first, the voice interaction unit 1 calculates a likelihood of each domain in one word for the words included in the recognized text using data of the entire parser model 17. Then, the voice interaction unit 1 determines the domain in one word on the basis of the likelihood. Thereafter, the voice interaction unit 1 calculates a likelihood (word score) of each class set (categorized text) in one word by using data of a part classified in a domain of a determined type out of the parser model 17. The voice interaction unit 1 then determines the categorized text in one word on the basis of the word score.

Similarly, the voice interaction unit 1 calculates the likelihood of each domain in two words for each of two-word sequence included in the recognized text and determined the domain of two words on the basis of the likelihood. Furthermore, the voice interaction unit 1 calculates the likelihood of each class set in two words (two-word score) and determines the class set (categorized text) in two words on the basis of the two-word score. Furthermore, similarly the voice interaction unit 1 calculates the likelihood of each domain in three words for a three-word sequence included in the recognized text and determines the domain in the three words on the basis of the likelihood. Furthermore, the voice interaction unit 1 calculates a likelihood (three-word score) of each class set in three words and determines a class set (categorized text) in three words on the basis of the three-word score.

Subsequently, the voice interaction unit 1 calculates the likelihood (parsing score) of each class set in the entire recognized text on the basis of each class set determined in one word, two words, and three words and the score of the class set (one-word score, two-word score, and three-word score). Thereafter, the voice interaction unit 1 determines the class set (categorized text) in the recognized entire text on the basis of the parsing score.

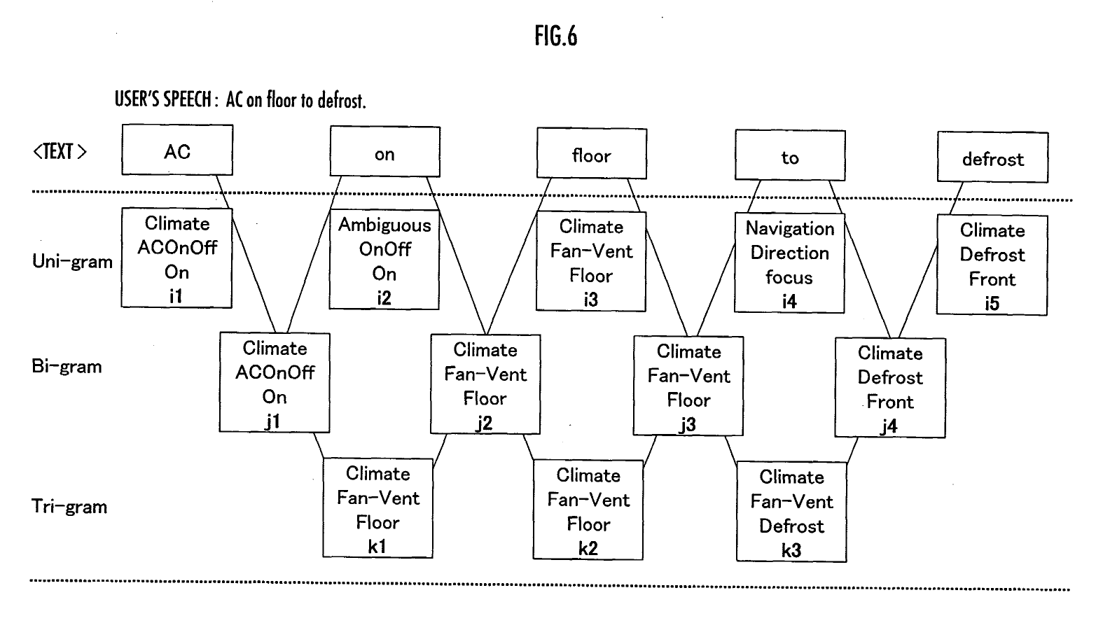

Here, the following describes processing of determining the categorized text using the parser model 17 with reference to an example shown in FIG. 6. In the example shown in FIG. 6, the recognized text is “AC on floor to defrost.”

In the above, the likelihood of each domain in one word is calculated by uni-gram for “AC,” “on,” . . . “defrost” by using the entire parser model 17. Thereafter, the domain in one word is determined based on the likelihood. For example, the top (highest in likelihood) domain is determined to be {Climate} for “AC,” {Ambiguous} for “on,” and {Climate} for “defrost.” Furthermore, the likelihood for each class set in one word is calculated for “AC,” “on,” . . . and “defrost” by uni-gram using data of the part classified in the determined domain type in the parser model 17. Then, the class set in one word is determined on the basis of the likelihood. For example, for “AC,” the top (highest in likelihood) class set is determined to be (Climate_ACOnOff_On) and the likelihood (word score) i1 for the class set is obtained. Similarly, for “on,” “defrost,” the class sets are determined and the likelihoods (word scores) i2 to i5 for the class sets are obtained.

Similarly, the likelihood of each domain in two words is calculated by bi-gram for “Ac on,” “on floor,” . . . “to defrost” and the domain in two words is determined on the basis of the likelihood. Then, the class sets in two words and their likelihoods (two-word score) j1 to j4 are determined. Furthermore, similarly the likelihood of each domain in three words is calculated by tri-gram for “AC on floor,” “on floor to,” and “floor to defrost” and each domain in three words is determined on the basis of the likelihood. Then, the class sets in three words and their likelihoods (three-word scores) k1 to k3 are determined.

Subsequently, regarding the class sets determined in one word, two words, and three words, for example, the sum of relevant scores among the word scores i1 to i5, the two-word scores j1 to j4, and the three-word scores k1 to k3 of the respective class sets is calculated as a likelihood (parsing score) for each class set in the entire text. For example, the parsing score for (Climate_Fan-Vent_Floor) is i3+j2+j3+k1+k2. Moreover, the parsing score for (Climate_ACOnOff_On) is i1+j1. Further, for example, the parsing score for (Climate_Defrost_Front) is i5+j4. Then, the class sets of the entire text (categorized texts) are determined on the basis of the calculated parsing scores. This determines categorized texts such as {Climate_Defrost_Front}, {Climate_Fan-Vent_Floor}, and {Climate_ACOnOff_On} from the recognized texts.

Subsequently, the voice interaction unit 1 determines a categorized text from the recognized texts by using the proper noun dictionary 21. Specifically, regarding each word in the recognized text, the voice interaction unit 1 calculates the degree of similarity between the text of the word and the text of each proper noun registered in the proper noun dictionary 21. Then, the voice interaction unit 1 determines the proper noun whose degree of similarity satisfies a give condition among the plurality of registered proper nouns to be a word included in the text. The given condition is previously determined such that, for example, the degree of similarity should be equal to or higher than a give value where the texts are clearly thought to be consistent with each other. Then, the voice interaction unit 1 determines the categorized text on the basis of the content of the tag appended to the proper noun. In addition, the voice interaction unit 1 calculates the likelihood (parsing score) of the determined categorized text on the basis of the calculated degree of similarity.

Subsequently, the voice interaction unit 1 determines the categorized text whose calculated parsing score satisfies a given condition as a recognition result of the input speech and outputs it together with the confidence factor (parsing score) of the recognition result. The given condition is previously determined such as, for example, a text whose parsing score is the highest, a text whose parsing score ranges from a high order to a given order, or a text whose parsing score is equal to or higher than a given value. For example, if the speech “AC on floor to defrost” is input as described above, {Climate_Defrost_Front} is output as a recognition result together with its parsing score.

Subsequently, in step 5, the voice interaction unit 1 obtains a detected value of the state of the vehicle 10 (the running condition of the vehicle 10, the state of apparatuses mounted on the vehicle 10, a driver's condition of the vehicle 10, or the like), which is detected by the vehicle state detection unit 3.

Next, in step 6, the voice interaction unit 1 determines a scenario for a response to the driver or for apparatus control by using the scenario database 18 on the basis of the recognition result of the speech output in step 4 and the state of the vehicle 10 detected in step 5.

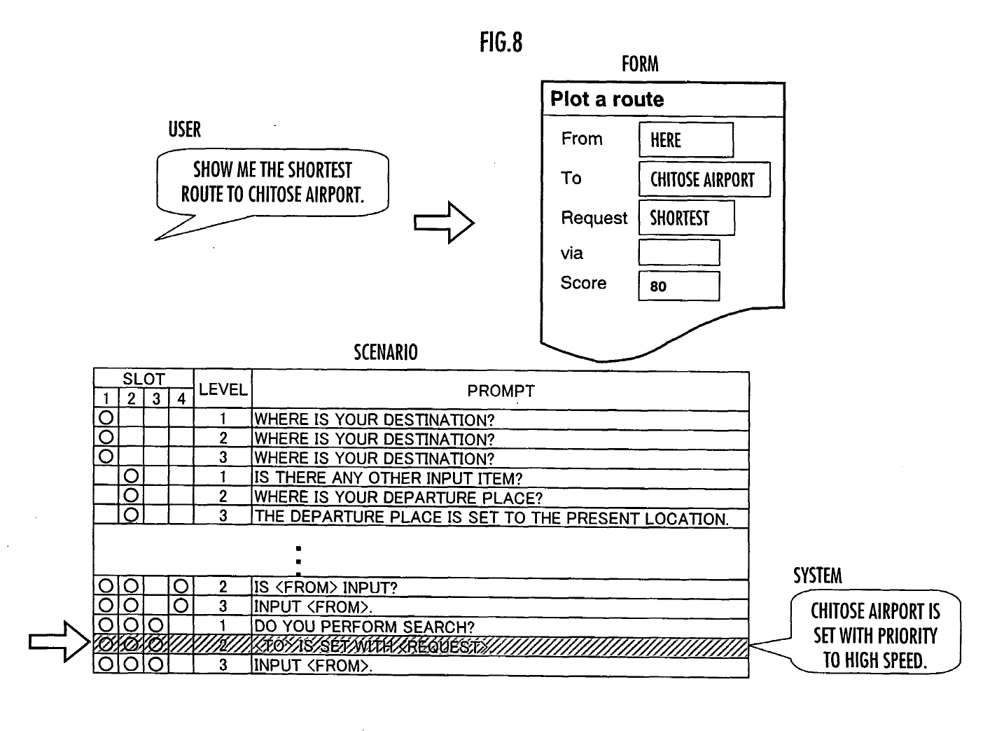

First, the voice interaction unit 1 obtains information for controlling the object from the recognition result of the speech and the state of the vehicle 10. As shown in FIG. 8, the voice interaction unit 1 is provided with a plurality of forms for storing information for use in controlling the object. Each form has a given number of slots corresponding to classes of necessary information. For example, the voice interaction unit 1 is provided with “Plot a route,” “Traffic info.” and the like as forms for storing information for use in controlling the navigation system 6b and provided with “Climate control” and the like as forms for storing information for use in controlling the air conditioner 6c. In addition, the form “Plot a route” has four slots “From,” “To,” “Request,” and “via.”

The voice interaction unit 1 inputs values into the slots of the corresponding form based on the recognition result of the speech of each round in an interaction with the driver and the state of the vehicle 10. In addition, it calculates the confidence factor of each form (the degree of confidence in a value input in the form) and records it in the form. The confidence factor of the form is calculated based on, for example, the confidence factor of the recognition result of the speech of each round and the extent to which the slots of each form are filled. For example, as shown in FIG. 8, if the driver inputs a speech “Show me the shortest route to Chitose Airport,” “Here,” “Chitose Airport,” and “Shortest” are entered into the slots “From,” “To,” and “Request” of the form “Plot a route.” In addition, a confidence factor of the calculated form is recorded as 80 in “Score” of the form “Plot a route.”

Subsequently, the voice interaction unit 1 selects the form for use in an actual control process on the basis of the confidence factor of the form and the state of the vehicle 10 detected in step 5. Thereafter, it determines a scenario by using the data stored in the scenario database 18 on the basis of the selected form. As shown in FIG. 8, the scenario database 18 stores, for example, response sentences and the like to be output to the driver with being classified according to the extent to which the slots are filled or according to levels. The levels are values set, for example, on the basis of the confidence factor of the form or the state of the vehicle 10 (the running condition of the vehicle 10, the driver's condition, or the like).

For example, if there is an available slot (a slot in which no value is entered) in the selected form, the voice interaction unit 1 determines a scenario for outputting a response sentence, which prompts the driver for the input to the available slot in the form, to the driver. In this case, an appropriate response sentence prompting the driver for the next speech is determined according to the level, in other words, in consideration of the confidence factor of the form or the state of the vehicle 10. For example, according to the driving load on the driver, a response sentence is determined with the number of slots prompting an input set relatively low in the state where the driving load is thought to be high. Then, the output of the response sentence determined in this manner prompts the user for the next speech, by which an efficient interaction is performed.

In the example shown in FIG. 8, values are entered in the first to third slots “From,” “To,” and “Request” of the form “Plot a route,” but no value is entered in the fourth slot “via.” In addition, the level is set to 2. In this condition, a response sentence “<To> is set with <Request>” is selected from the scenario database 18 and the content of a response sentence “Chitose Airport is set with priority to high speed” is determined.

Furthermore, for example, if all slots in the selected form are filled (values are entered in all slots), the voice interaction unit 1 determines a scenario for outputting a response sentence confirming the content (for example, a response sentence notifying the driver of an input value of each slot).

Subsequently, in step 7, the voice interaction unit 1 determines whether the interaction with the driver is completed on the basis of the determined scenario. If the determination result of step 7 is NO, the control proceeds to step 8, where the voice interaction unit 1 synthesizes the voice according to the content of the determined response sentence or the condition on outputting the response sentence. Then, in step 8, the generated response sentence is output from the loudspeaker 4.

Then, returning to step 1, the driver inputs a second speech. Then, in step 2, the voice interaction unit 1 performs processing of determining a domain type and processing of determining a task type from the recognition result of the first speech. If the domain type is determined, the voice interaction unit 1 validates the data of the determined domain type. If the task type is determined, the voice interaction unit 1 validates the data of the determined task type.

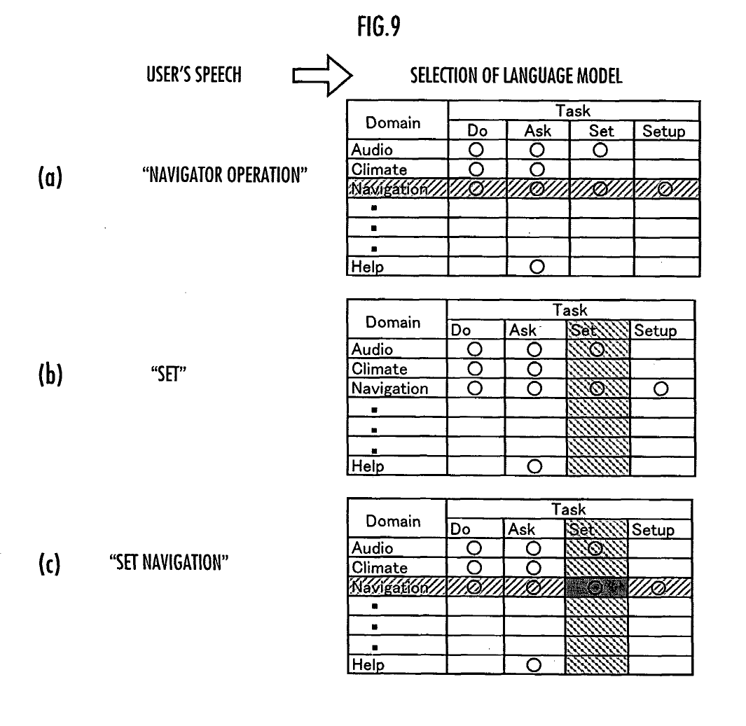

The following describes processing of selectively validating the language model 16 with reference to FIG. 9. In the example shown in FIG. 9, the language model 16 is classified as shown in FIG. 3.

For example, as shown in FIG. 9(a), if the driver inputs a speech “navigator operation” as a first speech, the recognition result of the speech is {Navigation}. Therefore, in step 2, the domain type is determined to be {Navigation} from the recognition result of the first speech. Therefore, as shown by hatching in the table in FIG. 9(a), only data of the part classified in {Navigation} is validated in the language model 16. Accordingly, if it is identified what should be controlled, the recognition object can be limited with a domain type index.

In addition, for example, as shown in FIG. 9(b), if the driver inputs a speech “set” as a first speech, the recognition result of the speech is {Ambiguous_Set}. Therefore, in step 2, the domain type is not determined since it is ambiguous “what” should be controlled from the recognition result of the first speech. On the other hand, the task type is determined to be {Set} on the basis of the speech. Thereby, as shown by hatching in the table in FIG. 9(b), only data of the part classified in {Set} is validated in the language model 16. Therefore, even if what should be controlled is not identified, the recognition object can be limited with the task type index only if at least it is identified how the object should be controlled.

Furthermore, for example, as shown in FIG. 9(c), if the driver inputs a speech “set navigation” as a first speech, the recognition result of the speech is {Navigation_Set}. Therefore, in step 2, the domain type is determined to be {Navigation} from the recognition result of the first speech and the task type is determined to be {Set}. Thereby, as shown in FIG. 9(c), only data of the part classified in both of {Navigation} and {Set} is validated in the language model 16. Therefore, the recognition object can be limited more efficiently if both of the domain type and the task type are determined.

Then, in step 3, the voice interaction unit 1 performs voice recognition processing similarly to the first speech. The voice interaction unit 1, however, performs voice recognition processing of the second speech from the driver by using only data of the part validated in step 2 in the language model 16. This allows the recognition object to be limited efficiently in performing the voice recognition processing, which improves the text recognition accuracy.

Then, in step 4, the voice interaction unit 1 performs parsing processing from the recognized text similarly to the first speech. In this processing, the accuracy of the text recognized in step 3 is improved, which thereby improves the accuracy of the recognition result of the speech output in step 4.

Subsequently, the voice interaction unit 1 detects the state of the vehicle 10 similarly to the first speech in step 5 and determines a scenario on the basis of the recognition result of the second speech and the state of the vehicle 10 in step 6.

Then, in step 7, the voice interaction unit 1 determines whether the interaction with the driver is completed. If the determination result of step 7 is NO, the control proceeds to step 8, where the voice interaction unit 1 synthesizes the voice according to the content of the determined response sentence or the condition on outputting the response sentence. Then, in step 9, the generated response sentence is output from the loudspeaker 4.

Thereafter, the same processing as steps 1 to 6, 8, and 9 is repeated for the above second speech until the determination result of step 7 becomes YES.

If the determination result of step 7 is YES, the control proceeds to step 10, where the voice interaction unit 1 synthesizes the voice of the determined response sentence. Next in step 11, the response sentence is output from the loudspeaker 4. Subsequently, in step 12, the voice interaction unit 1 controls the apparatuses on the basis of the determined scenario and terminates the voice interaction processing.

The above processing allows the language model 16 and the proper noun dictionary 20 to be selected efficiently, which improves the recognition accuracy of the speech, and therefore the apparatuses are controlled via efficient interactions.

[Example of Interaction]

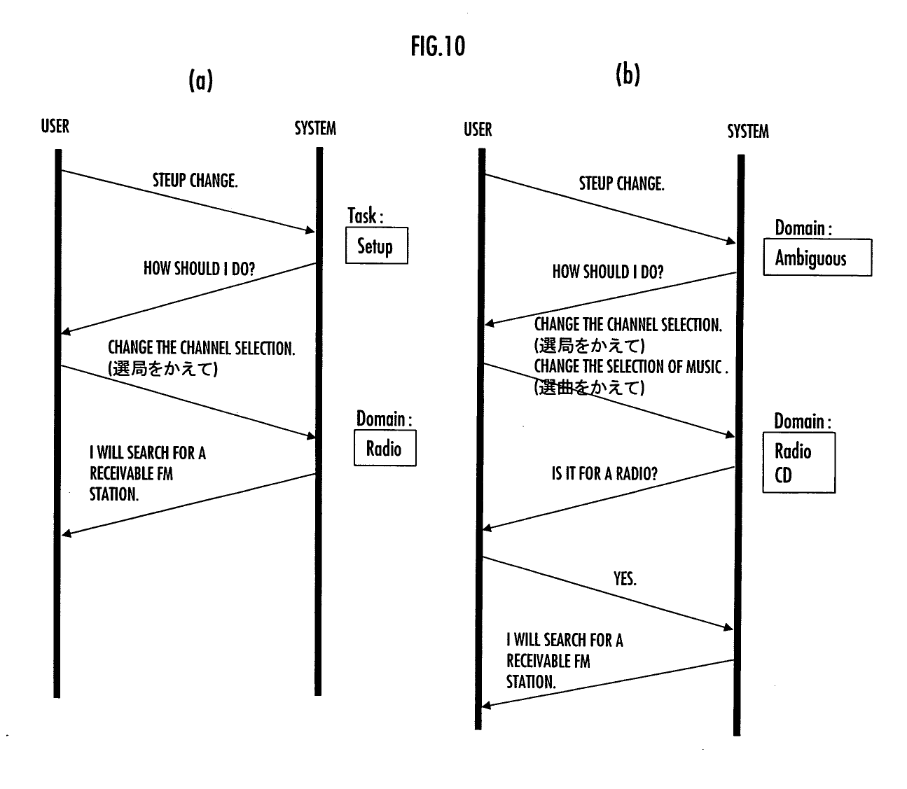

The following describes the above voice interaction processing by using examples of interactions shown in FIGS. 10(a) and (b). Both of the examples of the interactions shown in FIGS. 10(a) and (b) are those where a driver changes the channel selection of a radio. FIG. 10(a) shows an example of an interaction through the above voice interaction processing, and FIG. 10(b) shows an example of an interaction in which the task type is determined in step 2 and the selection of the language model 16 is omitted in the above voice interaction processing as a referential example. Both of the examples of the interactions are given in Japanese, specifically the driver's speech in the interactions includes a homonym given in Japanese. In the examples of interactions described below, the words of each of speeches in the interactions are given in both Japanese and English, furthermore, if necessary, given in romaji notation.

First, the example of the interaction in FIG. 10(b) will be described as a referential example below. As shown in FIG. 10(b), first in step 1, the driver inputs [symbol] (Setup change)” as a first speech. Next, in step 2, data of the entire language model 16 is validated since it is the first speech.

Then, in step 3, first, pronunciation data “se-t-te-i” and “he-n-ko-u” are determined from the feature vector of the input voice [symbol] (Settei henkou:Setup change)” together with sound scores. Subsequently, words [symbol] (setup)” and [symbol] (change)” are determined based on the language scores from the pronunciation data “se-t-te-i” and “he-n-ko-u” by using the data recorded in the entire language model 16. In the above, the language score of [symbol] (setup)” is calculated based on the appearance probability of the word [symbol] (setup)” since it is located at the beginning of the sentence. Further, the language score of [symbol] (change)” is calculated based on the appearance probability of the word [symbol] (change)” and the occurrence probability of a two-word sequence [symbol] (Setup change)”.

Subsequently, calculation is made on the degree of similarity between the pronunciation data “se-t-te-i” and “he-n-ko-u” and pronunciation data of proper nouns registered in the entire proper noun dictionary 20. In this case, there is no proper noun whose degree of similarity is equal to or higher than a given value among the registered proper nouns, and therefore the words are not determined.

Then, voice recognition scores are calculated from the sound scores and language scores for determined words. Thereafter, a text [symbol] (Setup change)” recognized from the input speech is determined on the basis of the sound recognition scores.

Subsequently, in step 4, a categorized text {Ambiguous_Setup} is determined on the basis of the parsing score from the recognized text [symbol] (Setup change)” by using the parser model 17. Thereafter, calculation is made on the degree of similarity between the words of the recognized text [symbol] (Setup change)” and the texts of the proper nouns registered in the entire proper noun dictionary 21. In this case, there are no proper nouns whose degree of similarity is equal to or higher than a given value among the registered proper nouns, and therefore the categorized text is not determined. Thereby, the categorized text {Ambiguous_Setup} is output as a recognition result together with the parsing score.

Subsequently, the state of the vehicle 10 is detected in step 5 and a scenario is determined in step 6. Since information on “what” should be controlled has not been obtained yet at this moment, the voice interaction unit 1 determines a scenario for outputting a response prompting the driver to entering a control object. Specifically, it determines a scenario for outputting a response sentence [symbol] (How should I do?)” as a response to the driver. Then, it is determined that the interaction is not completed in step 7, the control proceeds to step 8, where the voice of the determined response sentence is synthesized, and the response sentence is output from the loudspeaker 4 in step 9.

Returning to step 1, the driver inputs a second speech [symbol] (Change the channel selection)”. Next, in step 2, the processing of determining the domain type is performed from the recognition result {Ambiguous_Setup} of the first speech and then the domain type is determined to be {Ambiguous}. Thereafter, data of the entire language model 16 is considered valid since the domain type is ambiguous. At this point, the language model 16 is not selected according to the task type.

Next in step 3, first, the pronunciation data (“se-n-kyo-ku,” “wo,” and “ka-e-te”) are determined together with the sound scores from the feature vector of the input voice [symbol] (Senkyoku wo kaete:Change the channel selection).” Thereafter, the voice interaction unit 1 performs processing of determining a text recognized from the pronunciation data (“se-n-kyo-ku,” “wo,” and “ka-e-te”) by using the data of the entire language model 16.

In the above, it is assumed that the words [symbol] (channel selection),” [symbol] (selection of music),” and [symbol] (one thousand pieces of music)” whose pronunciation data is “se-n-kyo-ku” are recorded in the language model 16 as shown in Table 1. In other words, the words [symbol] (senkyoku:channel selection),” [symbol] (senkyoku:selection of music),” and [symbol] (senkyoku:one thousand pieces of music)” are homonyms given in Japanese. Then, the words [symbol] (channel selection),” [symbol] (selection of music),” and [symbol] (one thousand pieces of music)” exist in data of the {Audio} domain of the language model 16 for the pronunciation data “se-n-kyo-ku” and their appearance probabilities are recorded. There is no word corresponding to the pronunciation data “se-n-kyo-ku” in data of the {Navigation}, {Climate}, and {Ambiguous} domains of the language model 16. Further, [symbol] (channel selection)” exists only in {Radio} which is a subordinate domain of the {Audio} domain and [symbol] (selection of music)” and [symbol] (one thousand pieces of music)” exist only in {CD} which is a subordinate domain of the {Audio} domain.

On the other hand, only a word [symbol] (channel selection)” exists corresponding to the pronunciation data “se-n-kyo-ku” in {Setup} task data of the language model 16, and its appearance probability is recorded. Further, words [symbol] (selection of music)” and [symbol] (one thousand pieces of music)” exist corresponding to the pronunciation data “se-n-kyo-ku” in {Set} domain data of the language model 16 and their appearance probabilities are recorded.

TABLE 1

| | Task | | |
|---|---|---|---|
| Domain | Do | Set | Setup |

| | | | |
|---|---|---|---|
| Audio | Radio | — | [symbol] (channel |
| | | | selection) |
| | CD | [symbol] (selection of | — |
| | | music) | |
| | | [symbol] (one thousand | |
| | | pieces of music) | |

Navigation
Climate
Ambiguous

Accordingly, in step 3, the words [symbol] (selection of music)” and [symbol] (one thousand pieces of music)” which are homonyms of the word [symbol] (channel selection)” are also determined from the pronunciation data “se-n-kyo-ku” together with the word [symbol] (channel selection).” Therefore, the recognized texts [symbol] (Change the channel selection)”, [symbol] (Change the selection of music)”, and [symbol] (Change one thousand pieces of music)” are determined.

Subsequently, in step 4, the categorized texts {Audio_Setup_Radio_Station} and {Audio_Set_CD} having equivalent parsing scores are determined as recognition results from the recognized texts [symbol] (Change the channel selection)”, [symbol] (Change the selection of music)”, and [symbol] (Change one thousand pieces of music)”. In other words, the word [symbol] (channel selection)” is determined in step 3 and therefore classes {Radio} and {Station} are determined to be classes having high likelihoods. In addition, the words [symbol] (selection of music)” and [symbol] (one thousand pieces of music)” are determined in step 3 and therefore a class {CD} is determined to be a class which is high in likelihood.

Subsequently, the state of the vehicle 10 is detected in step 5 and a scenario is determined based on the recognition result of the speech and the vehicle state in step 6. Then, values are entered in a slot of the form for storing information for use in controlling a radio of the audio system 6a and a slot of the form for storing information for use in controlling the CD, respectively. Since {Audio_Setup_Radio_Station} and {Audio_Set_CD} have equivalent parsing scores, the confidence factor of the forms are equivalent and which is intended by the driver cannot be determined. Therefore, the voice interaction unit 1 determines a scenario for outputting a response sentence [symbol] (Is it for a radio?)” to confirm the driver's intention.

Then, returning to step 1, the driver inputs a third speech [symbol] (Soo:Yes).” Subsequently, in step 2, the domain type {Audio} is determined from the recognition result {Audio_Setup_Radio_Station} of the second speech and data of a part classified in {Audio} of the language model 16 is validated. Next, in step 3, pronunciation data “so-o” is determined from the voice of the input speech and the recognized text [symbol] (Yes)” is determined. Then, in step 4, a categorized text {Ambiguous_Yes} is determined from the recognized text [symbol] (Yes).”

Next, the state of the vehicle 10 is detected in step 5 and a scenario is determined based on the recognition result of the speech and the vehicle state in step 6. The recognition result is {Ambiguous_Yes} in the above, and therefore a form for storing information for use in controlling the radio of the audio system 6a is selected. Since all necessary information is entered, a response sentence confirming the input values is output and a scenario for controlling the radio of the audio system 6a is determined. More specifically, the voice interaction unit 1 determines a scenario for outputting a response sentence “I will search for a receivable FM station” as a response to the driver and then changing a received frequency of the radio of the audio system 6a. Then, it is determined that the interaction is completed in step 7 and the control proceeds to step 10, where voice of the determined response sentence is synthesized, synthesized voice is output from the loudspeaker 4 in step 11, and the received frequency of the radio of the audio system 6a is changed in step 12. Thereafter, slots of each form are initialized and the voice interaction processing is terminated.

On the other hand, in the example of an interaction in FIG. 10(a), the first speech [symbol] (Setup change)” from the driver and the response [symbol] (How should I do?)” from the system and the second speech from the driver [symbol] (Change the channel selection)” are the same as those in the example of the interaction in FIG. 10(b). In step 2, however, processing of determining the domain type and the task type is performed based on the recognition result {Ambiguous_Setup} of the first speech and the domain type {Ambiguous} and the task type {Setup} are determined. Then, data of the part whose task type is classified in {Setup} in the language model 16 is validated.

Then, in step 3, first, pronunciation data (“se-n-kyo-ku,” “wo,” and “ka-e-te”) are determined from the feature vector of the input voice [symbol] (Senkyoku wo kaete:Change the channel selection)” together with the sound scores. Subsequently, processing of determining a text from the pronunciation data (“se-n-kyo-ku,” “wo,” and “ka-e-te”) is performed by using data of the part classified in {Setup} of the language model 16.

In the above, only the data of the part whose task type is classified in {Setup} of the language model 16 is validated in step 2, and therefore only the word [symbol] (channel selection)” is determined for the pronunciation data “se-n-kyo-ku” and there is no possibility that the words [symbol] (selection of music)” and [symbol] (one thousand pieces of music)” are determined. Thus, only the recognized text [symbol] (Change the channel selection)” is determined.

Next in step 4, the categorized text {Audio_Setup_Radio_Station} is determined as a recognition result from the recognized text [symbol] [Change the channel selection]”). As described above, only the word [symbol] (channel selection)“is determined in step 3 and therefore only {Audio_Setup_Radio_Station} is determined as a recognition result.

Subsequently, the state of the vehicle 10 is detected in step 5 and a scenario is determined on the basis of the recognition result of the speech and the vehicle state in step 6. At this point, values are entered in the slots of the form for storing the information for use in controlling the ratio of the audio system 6a. Since all necessary information have been entered, the voice interaction unit 1 outputs a response sentence for confirming the input values and determines a scenario for controlling the ratio of the audio system 6a. Specifically, it outputs a response sentence “I will search for a receivable FM station” to the driver and determines a scenario for performing processing of changing the received frequency of the radio of the audio system 6a.

Subsequently, it is determined that the interaction is completed in step 7 and the control proceeds to step 10, where the voice of the determined response sentence is synthesized, the synthesized voice is output from the loudspeaker 4 in step 11, and the received frequency of the radio of the audio system 6a is changed in step 12. Then, the slots of the forms are initialized and the voice interaction processing is terminated.

As described above, in the example of interaction in FIG. 10(a), the language model 16 is efficiently selected, thereby improving the recognition accuracy of the speech. This eliminates the necessity of making a response to confirm the driver's intention as shown in the referential example in FIG. 10(b), by which the apparatuses are controlled through an efficient interaction.

Although the domain type determination processing unit 22 and the task type determination processing unit 23 determine the domain type and the task type, respectively, from the recognition result of the speech in this embodiment, the task type and the domain type can be determined by a determination input unit 24 (a touch panel, a keyboard, an input interface with buttons and dials, or the like) indicated by a dotted line in FIG. 1 using the input information. The touch panel can be one with touch switches incorporated in the display.

In this case, in step 2 of the above voice interaction processing, the language model 16 and the proper noun dictionary 20 can be selectively validated by determining the domain type and the task type using the information input from the touch panel or the like also in the first speech from the driver. Then, the voice recognition processing is performed in step 3 by using data of the valid part and thereby the recognition accuracy of the text is improved also in the first speech and the recognition result output in the parsing processing in step 4 is improved in accuracy, whereby the apparatuses are controlled through a more efficient interaction.

Furthermore, although the vehicle state detection unit 3 is provided and the scenario control processing unit 13 determines a scenario according to the recognition result and the detected vehicle state in this embodiment, the vehicle state detection unit 3 can be omitted and the scenario control processing unit 13 can determine the scenario only according to the recognition result.

Still further, although the user who inputs voice is the driver of the vehicle 10 in this embodiment, the user can be an occupant other than the driver.

Moreover, although the voice recognition device is mounted on the vehicle 10 in this embodiment, it can be mounted on a movable body other than a vehicle. Further, it is not limited to a movable body, but is applicable to a system in which a user controls an object with speech.

What is claimed is:

1. A voice recognition device which determines a control content of a control object on the basis of a recognition result of an input voice, comprising:
a task type determination processing unit which determines the type of a task indicating the control content on the basis of a given determination input; and
a voice recognition processing unit which recognizes the input voice with the task of the type determined by the task type determination processing unit as a recognition object.

2. A voice recognition device according to claim 1, wherein the given determination input is data indicating a task included in a previous recognition result in the voice recognition processing unit regarding sequentially input voices.

3. A voice recognition device according to claim 1, further comprising a domain type determination processing unit which determines the type of a domain indicating the control object on the basis of the given determination input, wherein the voice recognition processing unit recognizes the input voice with the domain of the type determined by the domain type determination processing unit as a recognition object, in addition to the task of the type determined by the task type determination processing unit.

4. A voice recognition device according to claim 1, having voice recognition data classified into at least the task types for use in recognizing the voice input by the voice recognition processing unit, wherein the voice recognition processing unit recognizes the input voice at least on the basis of the data classified in the task of the type determined by the task type determination processing unit among the voice recognition data.

5. A voice recognition device according to claim 3, having voice recognition data classified into the task and domain types for use in recognizing the voice input by the voice recognition processing unit, wherein the voice recognition processing unit recognizes the input voice on the basis of the data classified in the task of the type determined by the task type determination processing unit and in the domain of the type determined by the domain type determination processing unit among the voice recognition data.

6. A voice recognition device according to claim 4, wherein the voice recognition data includes a language model having at least a probability of a word to be recognized as data.

7. A voice recognition device according to claim 1, further comprising a control processing unit which determines the control content of the control object at least on the basis of the recognition result of the voice recognition processing unit and performs a given control process.

8. A voice recognition device according to claim 7, further comprising a response output processing unit which outputs a response to a user inputting the voice, wherein the control process performed by the control processing unit includes processing of controlling the response to the user to prompt the user to input the voice.

9. A voice recognition device having a microphone to which a voice is input and a computer having an interface circuit for use in accessing data of the voice obtained via the microphone, the voice recognition device determining a control content of a control object on the basis of a recognition result of the voice input to the microphone through arithmetic processing with the computer,
wherein the computer performs:
task type determination processing of determining the type of a task indicating the control content on the basis of a given determination input; and
voice recognition processing of recognizing the input voice with the task of the type determined in the task type determination processing as a recognition object.

10. A voice recognition method of determining a control content of a control object on the basis of a recognition result of an input voice, comprising:
a task type determination step of determining the type of a task indicating the control content on the basis of a given determination input; and
a voice recognition step of recognizing the input voice with the task of the type determined in the task type determination step as a recognition object.

11. A voice recognition program which causes a computer to perform processing of determining a control content of a control object on the basis of a recognition result of an input voice, having a function of causing the computer to perform:
task type determination processing of determining the type of a task indicating the control content on the basis of a given determination input; and
voice recognition processing of recognizing the input voice with the task of the type determined in the task type determination processing as a recognition object.
